(19) United States
(12) Patent Application Publication
(10) Pub. No.: US 2012/0096383 A1
(43) Pub. Date: Apr. 19, 2012

(54) LOADER ANIMATION

(75) Inventors: Manabu Sakamoto, Tokyo (JP); Panos Vassiliadis, San Leandro, CA (US)

(73) Assignees: Sony Network Entertainment Inc., Los Angeles, CA (US); Sony Corporation, Tokyo (JP)

(21) Appl. No.: 12/905,557

(22) Filed: Oct. 15, 2010

(51) Int. Cl. G06F 3/048

(52) U.S. Cl. 715/772

(57) ABSTRACT

Methods and apparatus are provided for displaying a loader animation by a device. In one embodiment, a method includes displaying a user interface, detecting a user selection of the user interface, displaying a loader animation based on the user selection, and updating the display of the user interface. The method may further include display of the loader animation include displaying a first element, the first element related to a color section of the animation, displaying a second element, the second element related to a brightness section and, displaying the first and second elements to appear as moving along a path, wherein the first and second elements move in opposite directions.

### FIELD

The present disclosure relates generally to display of a user interface, and more particularly to display of a loader animation for a user interface.

### BACKGROUND

Conventional methods and devices for display of a user interface typically include one or more graphical elements to assist a user in operation of the device. One common display element is a progress indicator. Sometimes referred to as a pre-loader animation, or preload animation, progress indicators can provide a user with an indication that a devices is currently operating or busy. A common type of progress indicator relates to display of a horizontal element, wherein progress is indicated by the display of color to fill the horizontal element. Another conventional type of progress indicator relates to display of a series of circular objects, wherein additional spherical objects are displayed in a line to indicate progress. Progress indicators may include display of a rotating elements, subsequent lighting of elements, and even text.

Typically, however, conventional progress indicators relate to low resolution displays for presentation on a computer monitor. Thus, one drawback of conventional progress indicators may be limited visual effects. Further, the display of a progress indicator is generally small. Accordingly, conventional progress indicators are generally designed for low resolution. Further, these conventional progress indicators are generally limited to display in one direction. For example, rotating progress indicators generally rotate in only one direction. What is desired is a graphical display which allows for direction and light to indicate progress which overcomes one or more of the above-identified drawbacks.

### BRIEF SUMMARY OF THE EMBODIMENTS

Disclosed and claimed herein are methods and apparatus for displaying a loader animation by a device. In one embodiment, a method includes displaying, by the device, a user interface, detecting a user selection of the user interface, and displaying a loader animation based on the user selection, wherein display of the loader animation relates to displaying a first element, the first element related to a colored section of the animation, displaying a second element, the second element related to a brightness section and, displaying the first and second elements to appear as moving along a path, wherein the first and second elements move in opposite directions. The method further includes updating the display of the user interface.

Other aspects, features, and techniques of the disclosure will be apparent to one skilled in the relevant art in view of the following detailed description.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a loader animation according to one embodiment;

FIG. 2 depicts a process for display of a loader animation according to one embodiment;

FIG. 3 depicts a simplified block diagram of a device according to one embodiment;

FIG. 4 depicts a graphical representation of a user interface according to one or more embodiments;

FIGS. 5A-5B depict graphical representations of loader animation elements according to one or more embodiments;

FIGS. 6A-6C depict graphical representations of loader animation placement according to one or more embodiments;

FIG. 7 depicts a process for displaying a loader animation according to another embodiment; and

FIG. 8 depicts a graphical representation of a loader animation according to another embodiment.

### DETAILED DESCRIPTION OF THE EXEMPLARY EMBODIMENTS

### Overview and Terminology

One aspect of the present disclosure relates to display of a loader animation. As used herein, a loader animation relates to a graphical display of one or more elements, wherein elements of the animation are positioned to appear as moving during display. For example, elements of the animation may rotate in opposite directions along a path. In one embodiment, display of the loader animation may employ direction and light of display elements to indicate processing and/or loading of data for display. Similarly, direction and light of display elements may be employed to indicate progress.

A loader animation may be provided for display in a user interface (e.g., graphical user interface). Based on user selection of the user interface, a device may be configured to display a loader animation while data is processed during one or more of data loading, retrieval and processing. A loader animation is provided that may be displayed by one or more devices such as a display device, personal communication device, media player, imaging device, network communication device, vehicle, etc. The loader animation may relate to an animated graphic display to identify one or more of loading data, processing data, waiting for data, and indicating progress.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the disclosure is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the disclosure are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

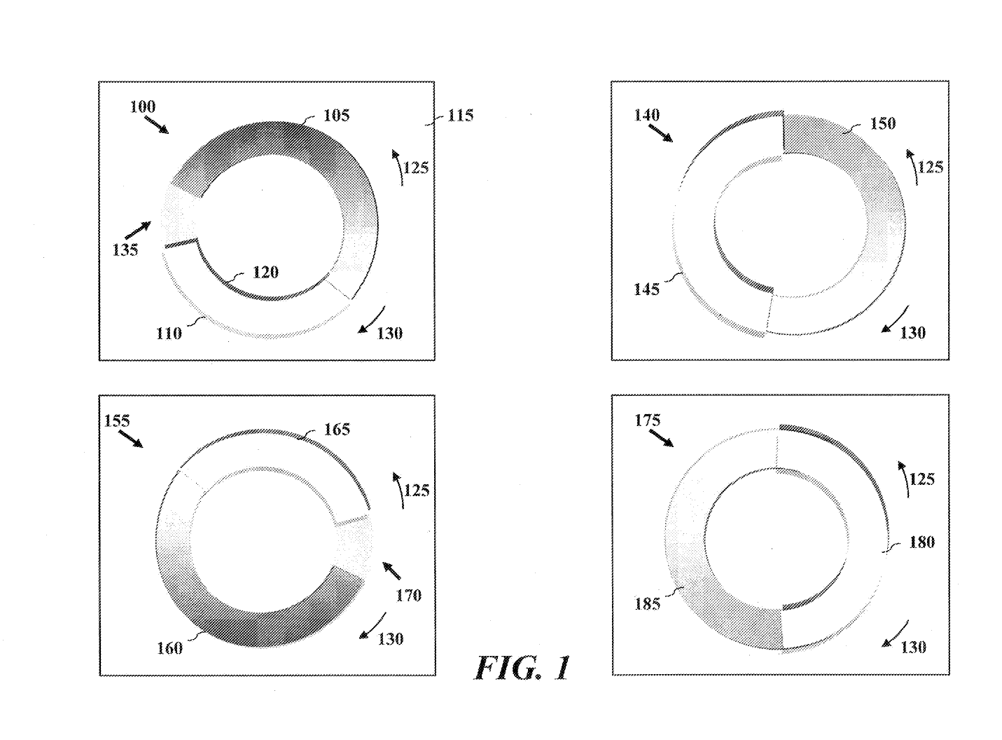

Referring now to the figures, FIG. 1 depicts a graphical representation of a loader animation according to one embodiment. A loader animation may be displayed based on a sequence of images to provide the illusion of moving graphics according to one embodiment. Accordingly, FIG. 1 depicts a images which may be represent one or more states of the loader animation.

Loader animation state 100 depicts a first element 105 and second element 110. The first and second elements may be displayed with one or more colors or brightness settings. For example, in one embodiment, first element 105 may be displayed as having a color applied to a graphical element. The color may be applied as a solid fill, or may be applied with one or more of a fill pattern or gradient. In another embodiment, second element 110 may be displayed as having a white fill or white fill pattern. Second element 110 may relate to a brightness section of the loader animation, the brightness section including a one or more of a specific brightness or varying brightness for the graphical element. In certain embodiments, brightness of the white fill element may indicate progress based on the size and brightness of the element. Elements 105 and 110 may further be displayed with a degree of transparency, such that a background color, shown as 115, may appear through the elements. In one embodiment, the second element covers the first element when rotating along the path in a similar position.

Display of loader animation 100 may additionally include one or more of a glow effect or accent and variable brightness applied to elements 105 and 110. By way of example, element 110 is depicted as having glow accent 120. In one embodiment, a glow accent may be generated based on the display of loader animation 100. For example, movement of elements 105 and 110 may generate the glow accent based on motion along a shaped path. In one embodiment, elements 105 and 110 may relate to layers, wherein display of one layer overlapping at least a portion of the other layer produces display effect, such as one or more of a different color and change in light intensity. According to another embodiment, display of one or more of elements 105 and 110 may include display of a glow accent associated with the element. According to another embodiment, the size and amount of glow accent 120 may be adjusted to indicate the speed of processing and/or amount of progress. For example, a larger glow accent 120 may indicate further progress. It may also be appreciated that display of the loader animation may provide an indication of processing by a device without providing an indication of progress.

According to another embodiment, display of loader animation 100 may include display of elements 105 and 110 to appear as moving, wherein the elements follow a circular path. In one embodiment, element 105 may rotate as shown by direction 125 and element 110 may rotate as shown by direction 130, wherein rotation relates to displaying the element as moving along a circular path. As will be further discussed, during rotating, element 110 may be displayed as covering element 105. According to another embodiment, elements of loader animation 100 may not be displayed along the entire path, as shown by space 135. Space 135 may result in a “c” shaped or partial ring shaped element being displayed. Although elements 105 and 110 are described as relating to a color section and brightness section, it should also be appreciated that other graphical display characteristics may be employed.

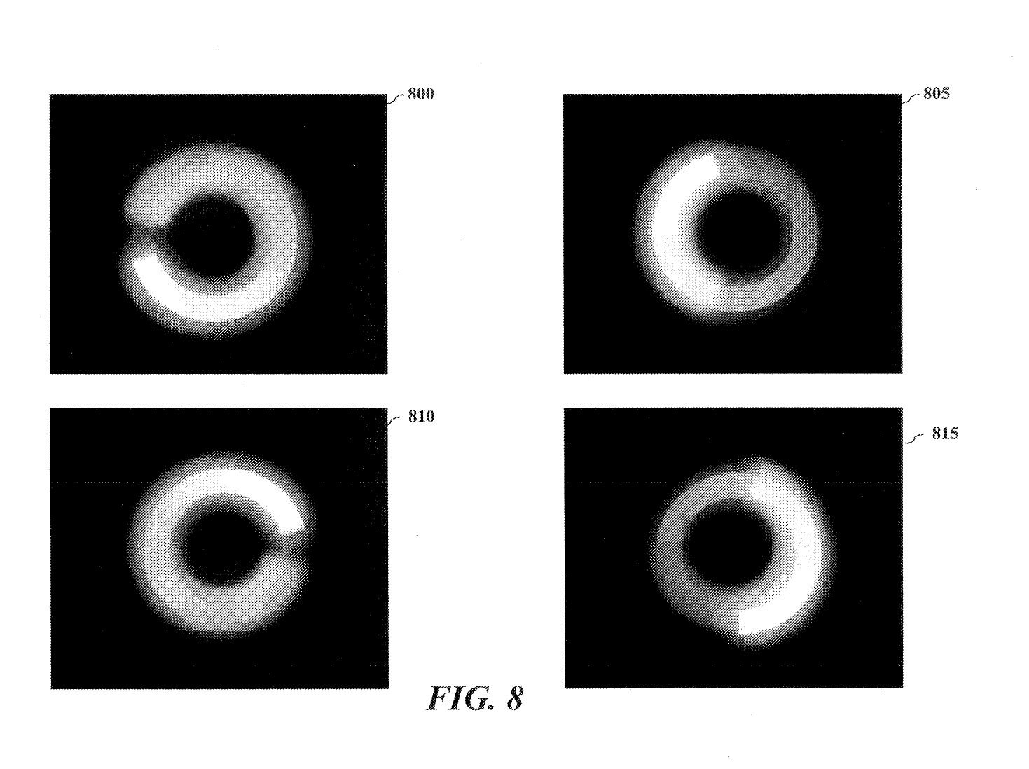

FIG. 1 further depicts the transition of the loader animation 100 wherein elements 105 and 110 are rotated. For example, loader animation 140 depicts the first element, shown as 145, covering the second element. Loader animation 140 may further display a trail, or semi-transparent path of the first element, shown as 150, wherein areas following the element may be displayed to include a transition from the brightness or color of the element to a white or colorless display. The trail effect may relate to blending a first element blended with the second element, wherein the first element is blended with the second element to generate a gradient display characteristic of the trail effect. As will be depicted below in more detail with reference to FIG. 8, the trail of the motion may be depicted along the path of motion.

Loader animation 155 depicts the first element in 160 and second element 165 in further positions relative to loader animation 140. Display of the elements are such that the elements continue to appear as moving along the circular path (e.g., rotating about a center point of the loader animation). Loader animation 155 may further include space 170, which is open. Loader animation 175 depicts the second element, shown as 180, covering the first element. A trail of the first element is shown as 185.

Although the loader animation of FIG. 1 has been described with a portion of images that may be displayed, it may be appreciated that the loader animation may include a plurality of images to provide a smooth transition of the first and second elements. Additionally, the loader animation may be configured to display the first and second elements along separate paths with the same direction of rotation, and/or separate paths along different directions of rotation. The display of the loader animation of FIG. 1 may further include display along a plurality of different paths, including but not limited to a helical path, oval path, square path, rectangular path and other paths in general. According to another embodiment, display of a loader animation may relate to a high resolution display of one or more elements to provide an animation for high-definition display configurations.

The loader animation of FIG. 1 may inform a user that a device is processing data, retrieving data, loading one or more files and/or to indicate progress. In one embodiment, the loader animation may be generated by multimedia platform and/or animation program for incorporation with a user interface. For example, the loader animation of FIG. 1 may be employed for a user interface associated with a display device, personal communication device, media player, imaging device, network communication device, vehicle, etc.

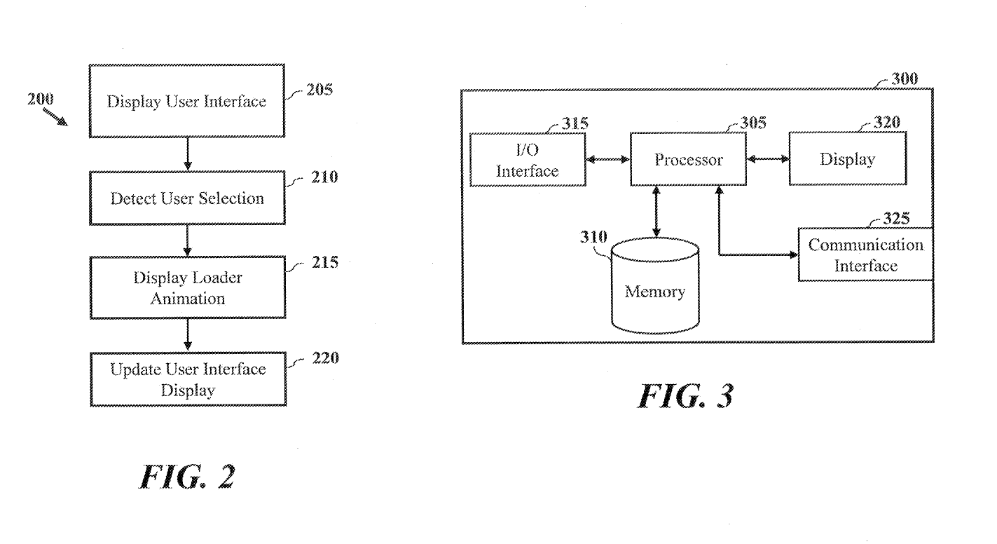

Referring now to FIG. 2, a process is depicted for displaying a loader animation according to one or more embodiments. Process 200 may be performed by a device including a display as will be described in more detail below with reference to FIG. 3. Process 200 may be initiated by displaying a user interface at block 205. In one embodiment, the user interface may be displayed for a device associated with one or more of a display device, personal communication device, media player, imaging device, network communication device, vehicle, etc. The user interface may include one or more elements for user selection.

Process 200 may continue by detecting user selection of the user interface at block 210. The user selection may relate to a network request for receiving data associated with a network address. In certain embodiments, the user selection may require that the device process data for a period of time (e.g., seconds, minutes, etc.). The device may determine that a delay may result before the user selection may be completed and/or the display may be updated. Accordingly, process 200 may display a loader animation based on the user selection at block 215. It may be appreciated that a loader animation may be displayed to identify one or more of loading data, processing data, waiting for data, and indicating progress. In one embodiment, display of the loader animation at block 215 may include display of a first element related to a first graphical display, and display of a second element related to second graphical display, the second graphical display different from the first. For example, display of the loader animation at block 215 may include display of a first element related to a color section of the animation, and a second element related to a brightness or white portion. Display may further relate to an animation which displays the first and second elements as moving along a path, or rotating about a central axis point, wherein the animation may be repeated for display by the user interface. For example, the first and second elements may appear as rotating along a path, wherein the first and second elements rotate in opposite directions. According to another embodiment, the first and second elements may relate to a half circle, or a portion of a half circle, wherein the first and second elements rotate in opposite directions such that the overlap of the first and second elements is results in a display color and/or brightness that is different from display of an element alone.

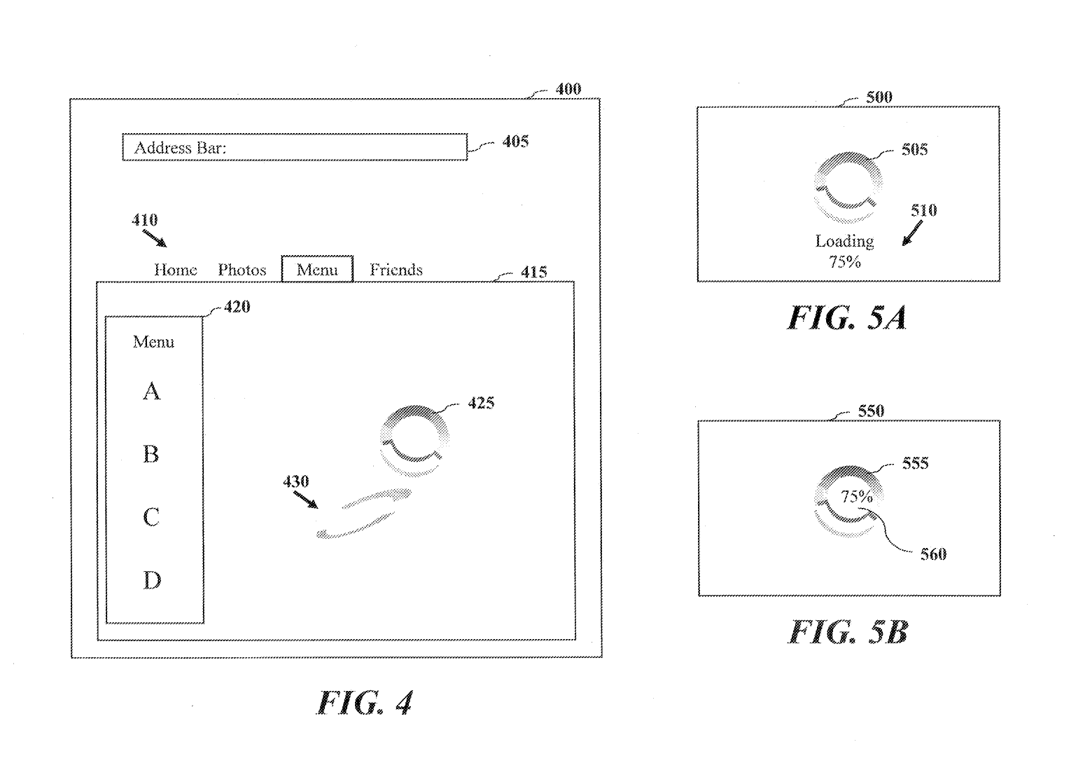

At block 220, process 200 may update the user interface display. For example, based on user selection of a new network address the user display may discontinue display of the loader animation for display of a data associated with a network address. According to another embodiment, updating the display at block 220 may relate to continued display of the loader animation to appear as rotating. For example, continuing display of the loader animation including continued motion of the first element and the second element associated with respective directions of movement. As will be discussed in more detail below with respect to FIGS. 4, 5A-5B and 6A-6C, one or more attributes of the loader animation, including position, may be arranged based on the type of user interface and loader animation attributes.

FIG. 3 depicts a simplified block diagram of a device according to one embodiment. In one embodiment, device 300 may be configured to provide a user interface for operation of a device. As shown in FIG. 3, device 300 includes processor 305, memory 310, input/output (I/O) interface 315, network communication interface 320, and display 325. Processor 305 may be configured to control operation of device 300 based on one or more computer executable instructions (e.g., computer readable code) stored in memory 310. Memory 310 may relate to one of RAM and ROM memories and may be configured to store one or more media files, content, and computer executable instructions for operation of device 300.

I/O interface 315 may include one or more buttons for user input, such as a numerical keypad, volume control, channel control, menu controls, pointing device, track ball, mode selection buttons, and playback functionality (e.g., play, stop, pause, forward, reverse, slow motion, etc). Buttons of I/O interface 315 may include hard and soft buttons, wherein functionality of the soft buttons may be based on one or more applications running on device 300. I/O interface 315 may be configured to allow for one or more devices to communicate with device 300 via wired or wireless communication. I/O interface 315 may include one or more ports for receiving data, including ports for removable memory. In another embodiment, device 300 may include one or more optical drives, not shown in FIG. 3, which may be configured to detect and decode one or more media files stored on a disc (e.g., CD, DVD™, Blu-ray™, etc.).

Network communication interface 320 may be configured to allow for network based communications including but not limited to LAN, WAN, Wi-Fi, etc. Display 325 may be employed to display a user interface for menu functions, network communication, device operation, etc.

Referring now to FIG. 4, a graphical representation is depicted of a user interface according to one or more embodiments. User interface 400 may relate to a user interface displayed by a device (e.g., device 300). In certain embodiments, user interface 400 may be provided by a network browser application. As depicted in FIG. 4, user interface 400 includes address bar 405 which may be employed to access the address of an network address (e.g., URL, internet address, etc.).

User interface 400 can include a plurality of tabs, shown as 410, each of which may be selectable by the user for one or more management functions associated with a device. Based on a user selection, such as “Menu” as depicted in FIG. 4, window 415 may be displayed to include menu 420 with one or more selections for a user. Based on user selection of user interface 400, loader animation 425 may be displayed. For example, user selection of one or more of address bar 405, tabs 410 and menu 420 may result in the device having to process, load and/or retrieve data. During the delay associated with the device operation, user interface 400 may display loader animation 425. Loader animation 425 relates to a graphical element, the display of which includes rotation of a first element in a first direction and a second element in a second direction, the first and second elements rotating along a circular path. Display of loader animation 425 may further include display of a shadow, shown as 430. In certain embodiments, shadow 430 may display a reflection of loader animation 425, wherein display elements of shadow 430 rotate.

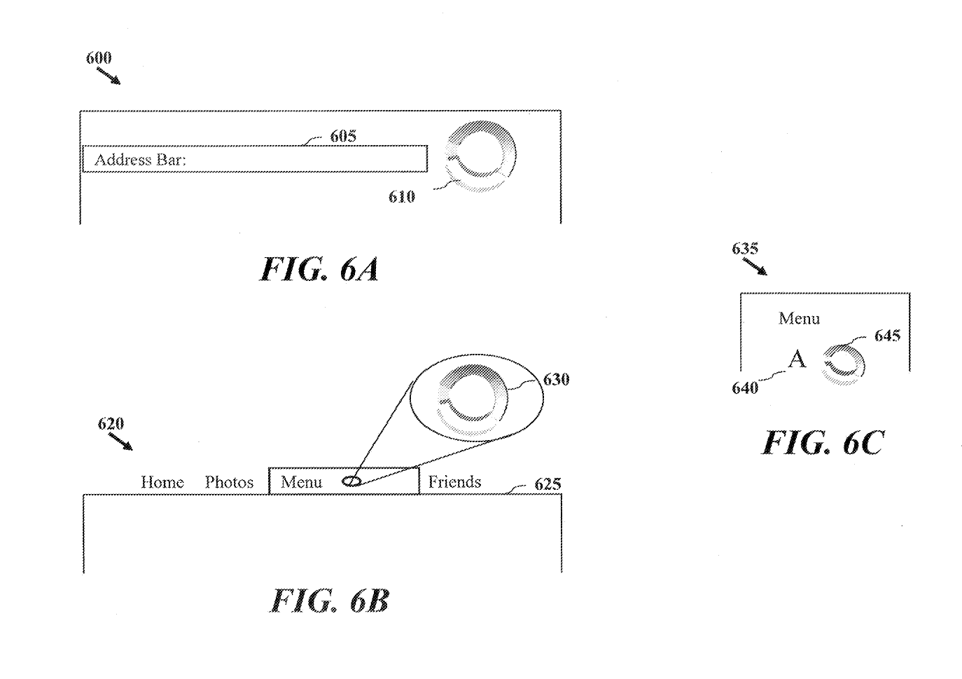

Although FIG. 4 depicts loader animation 420 as a graphical animation, it may be appreciated that the loader animation may include text and or a numerical value to indicate progress as will be discussed in more detail below with reference to FIGS. 5A-5B. It should also be appreciated that the position of a loader animation within the user interface may be associated with one or more positions as will be discussed in more detail below with reference to FIGS. 6A-6C.

Referring now to FIGS. 5A-5B, graphical representations of a loader animation are depicted according to one or more embodiments. Referring first to FIG. 5A, loader animation 500 is depicted to include animation 505 (e.g., loader animation 100) and text, shown as 510, indicating that data is loading and the percentage (e.g., a percentage indicator) of loaded data. Display of loader animation 500 may include updating text 510 such that a percentage of progress displayed is updated while data is loaded. Additionally, animation 505 may rotate and adjust brightness of one or more elements depending on the speed of progress for file loading. It should also be appreciated that text 510 may include different labels separate from loading.

Referring now to FIG. 5B, loader animation 550 is depicted to include animation 555 and progress indicator 560. Progress indicator 560 relates to a percentage and may be updated based on the progress of processing for a device and of loading of data. Additionally, animation 555 may rotate and adjust brightness of one or more elements depending on the speed of progress for file loading according to one embodiment.

Referring now to FIGS. 6A-6C, graphical representations of loader animation position in a user interface are shown according to one or more embodiments. Display of a loader animation (e.g., loader animation 100) may be positioned in one or more areas of a user interface. According to another embodiment, display of a loader animation may be based on the user selection. Referring now to FIG. 6A, a portion of a user interface is depicted as 600. The user interface includes address bar 605 (e.g., address bar 405) in which a user may enter a network address to request data. In one embodiment, based on user selection of a network address, display of the user interface may include display of loader animation 610 while data is retrieved for the user selection. Display of loader animation 610 may include rotation of first and second elements of the animation during the period that data is retrieved and/or processed.

Referring now to FIG. 6B, a portion of a user interface is depicted as 620 according to another embodiment. The user interface includes tabs 625 (e.g., tabs 410) in which a user may select one or more categories of data. In one embodiment, based on user selection of tabs 625, display of the user interface may include display of loader animation 630 within the selected tab while data is retrieved for the user selection. Display of loader animation 630 may rotate during retrieval of data. FIG. 6C depicts display of a user interface menu 635 (e.g., menu 425) wherein user selection of menu title 640 results in display of loader animation 645.

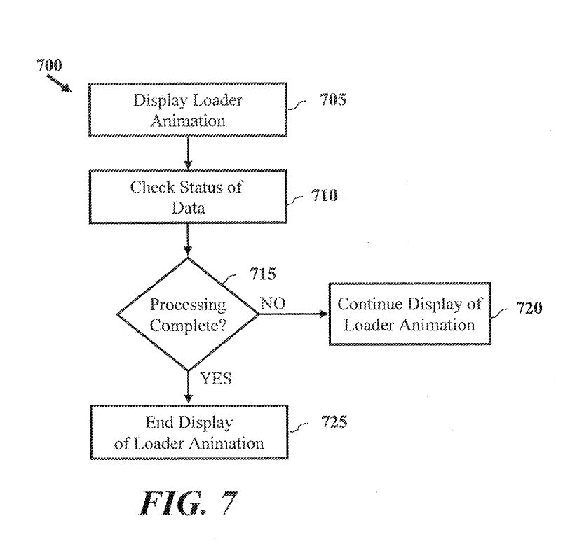

Referring now to FIG. 7, a process is depicted for displaying a loader animation according to one embodiment. Process 700 may be initiated by display of a loader animation at block 705. According to one embodiment, display of the loader animation may be based on device determination that processing is required to update the user interface resulting in a delay prior to display of elements based on the user selection. Delay may be associated with processing of data by a device, and/or awaiting retrieval of data from a network address. At block 710, the device may check to determine the status of data. Based on the status of data, the device may then determine if processing is complete at block 715. When processing is not complete (e.g., “NO” path out of decision block 715), the device may continue to display a loader animation at block 720. When processing is complete (e.g., “YES” path out of decision block 715), the device may end display of a loader animation at block 725 for display of data based on a user selection.

Referring now to FIG. 8, a graphical representation of the a loader animation is depicted according to one or more embodiments. FIG. 8 depicts a graphical representation of a glow affect applied to a loader animation. Display of loader animation 800 may then include a smooth transition to include loader animation depictions 805, 810 and 815 prior to returning to display loader animation 800. According to one embodiment, loader animation depictions 800, 805, 810 and 815 may relate to the loader animations depictions of FIG. 1.

While this disclosure has been particularly shown and described with references to exemplary embodiments thereof, it will be understood by those skilled in the art that various changes in form and details may be made therein without departing from the scope of the disclosure encompassed by the appended claims.

What is claimed is:

1. A method for displaying a loader animation by a device, the method comprising the acts of:
displaying, by the device, a user interface;
detecting a user selection of the user interface;
displaying a loader animation based on the user selection, wherein display of the loader animation relates to
displaying a first element, the first element related to a color section of the animation,
displaying a second element, the second element related to a brightness section and,
displaying the first and second elements to appear as moving along a path, wherein the first and second elements move in opposite directions; and
updating the display of the user interface.

2. The method of claim 1, wherein the user interface relates to a graphical user interface for one or more of an display device, personal communication device, media player, imaging device, network communication browser, and vehicle.

3. The method of claim 1, wherein the loader animation relates to an animated graphic display to identify one or more of loading data, processing data, waiting for data, and indicating progress.

4. The method of claim 1, wherein display of the loader animation relates to displaying the first and second elements as moving with respect to a circular path.

5. The method of claim 1, wherein display of the first element includes display of a trail effect, wherein the first element is blended with the second element to generate a gradient display characteristic of the trail effect.

6. The method of claim 1, wherein the first and second elements relate to partial ring shaped elements, and wherein overlap of the first and second elements produces a display effect.

7. The method of claim 1, wherein the second element is displayed to include a glow accent, the amount of glow accent indicating progress, and wherein the second element covers the first element when moving along the path in a similar position.

8. The method of claim 1, wherein updating the display relates to terminating display of the loader animation in order to display data based on the user selection.

9. The method of claim 1, wherein updating the display relates to continuing display of the loader animation including continued motion of the first element and the second element associated with respective directions of movement.

10. The method of claim 1, further comprising displaying one or more of text and a percentage indicator to indicate a percentage of progress during display of the loader animation.

11. A computer program product stored on computer readable medium including computer executable code for displaying a loader animation, the computer program product comprising:
computer readable code to display a user interface;
computer readable code to detect a user selection of the user interface;
computer readable code to display a loader animation based on the user selection, wherein display of the loader animation relates to
display of a first element, the first element related to a color section of the animation,
display of a second element, the second element related to a brightness section, and
display of the first and second elements to appear as moving along a path, wherein the first and second elements move in opposite directions; and
computer readable code to update the display of the user interface.

12. The computer program product of claim 11, wherein the user interface relates to a graphical user interface for one or more of an display device, personal communication device, media player, imaging device, network communication browser, and vehicle.

13. The computer program product of claim 11, wherein the loader animation relates to an animated graphic display to identify one or more of loading data, processing data, waiting for data, and indicating progress.

14. The computer program product of claim 11, wherein display of the loader animation relates to display of the first and second elements as moving with respect to a circular path.

15. The computer program product of claim 11, wherein display of the first element includes display of a trail effect, wherein the first element is blended with the second element to generate a gradient display characteristic of the trail effect.

16. The computer program product of claim 11, wherein the first and second elements relate to partial ring shaped elements, and wherein overlap of the first and second elements produces a display effect.

17. The computer program product of claim 11, wherein the second element is displayed to include a glow accent, the amount of glow accent indicating progress, and wherein the second element covers the first element when moving along the path in a similar position.

18. The computer program product of claim 11, wherein updating the display relates to terminating display of the loader animation in order to display data based on the user selection.

19. The computer program product of claim 11, wherein updating the display relates to continuing display of the loader animation including continued display of the first element and the second element associated with respective directions of movement.

20. The computer program product of claim 11, further comprising computer readable code to display one or more of text and a percentage indicator to indicate a percentage of progress during display of the loader animation.

21. A device, comprising:
a display;
a memory; and
a processor coupled to the display and memory, the processor configured to:
display a user interface;
detect a user selection of the user interface;
display a loader animation based on the user selection, wherein display of the loader animation relates to
display of a first element, the first element related to a color section of the animation,
display of a second element, the second element related to a brightness section, and
display of the first and second elements to appear as moving along a path, wherein the first and second elements move in opposite directions; and
update the display of the user interface.
